(19) United States
(12) Patent Application Publication
(10) Pub. No.: US 2008/0127565 A1
(43) Pub. Date: Jun. 5, 2008

(54) Expandable hinge assembly

(76) Inventor: Barry W. Taylor, Charleston, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/593,865

(22) Filed: Nov. 7, 2006

(51) Int. Cl. E06B 9/02; E05D 7/00

(52) U.S. Cl. 49/394

(57) ABSTRACT

An expandable hinge assembly for movably attaching an interior shutter to a window frame includes: (a) a window frame mounting plate member including two substantially planar and perpendicular segments, a first one being attachable to an inside surface of the window frame, the other, second window frame segment including a frame plate depression; (b) a shutter mounting plate member including two substantially planar and perpendicular segments, a first one being attachable to the shutter, the other, second shutter plate segment including at least one shutter plate knuckle on a longitudinal edge of the second shutter plate segment; and (c) a connecting member including two substantially planar and perpendicular segments, a first one including at least one knuckle along a longitudinal edge of the first connecting plate segment; the other, second segment including at least one connecting plate tongue corresponding to the frame plate depression; wherein the knuckles are detachably interlockable with one another; and the connecting plate tongue is detachably insertable in the corresponding frame plate depression. A shutter assembly including the expandable hinge assemblies and a shutter stile side extension is also included.

### BACKGROUND OF THE INVENTION

1. Technical Field

The present invention relates in general to a hinge for supporting two objects in rotational relationship to one another, and to a shutter assembly with a shutter stile side extension for accommodating the hinge, and more particularly to an expandable hinge assembly for a window shutter that allows the shutter to be opened wide, increasing clearance from the window, to facilitate tilting the window for cleaning, removal, or repair, and that also allows easy installation, removal, and/or reattachment of the shutter.

2. Background Information

A typical interior window shutter assembly has two shutters, left side and right side, each of which is attached to the window frame by means of hinges. The hinges permit each shutter to be opened away from the window by rotating on its hinges. Many double-hung window assemblies are constructed so that the window itself can be rotated in a horizontal plane within the frame, allowing the homeowner to tilt the window inward to make cleaning both sides of the window possible from inside the house. One difficulty with currently available interior window shutters is that, when fully opened, they allow only minimal clearance from the window frame, restricting the movement of the window pane and making it difficult or impossible to tilt the window inward for cleaning.

One common, conventional hinge consists of two plates, one of which is mounted to the inside of a door frame or window frame, and the other of which is mounted to the side edge of a door or shutter. The two plates are joined together along one edge of each by interlocking curved knuckles that join to form a barrel, through which a hinge pin is inserted. Such a hinge allows movement by rotation of the hinge plates on the pin. The barrel, however, typically protrudes from the surface plane of the plate attached to the door or window frame, and into the interior space of the door or window opening, where it may interfere with movement of a wide object through the opening. When the opening is a window frame, the window itself will typically extend almost the full width of the opening. When a double hung window is tilted inward for cleaning, maximum clearance is desired; the presence of a hinge barrel of a conventional shutter in the opening is likely to interfere with free inward movement of the window.

The hinge assembly of the present invention comprises basically three angled, detachable pieces, or members, at least two of which have been bent, or folded longitudinally, at approximately right angles. The two bent pieces, the shutter mounting plate member and the window frame mounting plate member, are joined together by a third, connecting member. The middle connecting member is also a substantially planar plate that has been folded longitudinally at about a right angle. The connecting member is joined to the shutter mounting plate member by a hinge barrel and retaining pin, and is joined to the window frame mounting plate member by sliding together interlocking tongues and depressions to create a substantially smooth surface. Because the smooth interlocking connection is flush with the mounting plate member, and does not protrude into the window opening, and because the use of the connecting member and the right angle bends in the mounting plate members and connecting member position the hinge barrel only on the joint between the connecting member and the shutter mounting plate member, the hinge barrel is not in the plane of the window opening. When fully assembled and installed on a window and shutter, the jointed, basically three-piece construction of the present hinge assembly allows the shutter to open substantially completely away from the window, and eliminates any interference with the tilting or removal of the window for cleaning, removal, or repair, for example.

### BRIEF SUMMARY OF THE INVENTION

The present invention is a slidable, expandable hinge assembly for movably attaching an interior shutter to a window frame, which includes:

(a) a window frame mounting plate member comprising two substantially planar segments that are substantially perpendicular to one another, a first one of which is attachable to an inside surface of the window frame, the other, second one of the window frame segments comprising a frame plate depression;

(b) a shutter mounting plate member comprising two substantially planar segments that are substantially perpendicular to one another, a first one of which is attachable to the shutter, the other, second one of the shutter plate segments comprising at least one shutter plate knuckle on a longitudinal edge of the second shutter plate segment; and

(c) a connecting member comprising two substantially planar segments that are substantially perpendicular to one another, a first one of which comprises at least one connecting plate knuckle along a longitudinal edge of the first connecting plate segment; the other, second segment of which comprises at least one connecting plate tongue corresponding to the frame plate depression; wherein the knuckles of the shutter mounting plate member and the connecting member are detachably interlockable with one another; and the connecting plate tongue is detachably insertable in the corresponding frame plate depression.

Advantages of the hinge assembly of the present invention include the following:

1) the middle connecting member allows the hinge barrel to be positioned away from the window frame, so that when the window shutter is opened, the shutter swings completely away from the window and the hinge barrel does not interfere with movement of the window during inward tilting; and

2) the shutter is easily removed and reattached by means of the interlocking sliding plates without the necessity of removing either mounting plate from the window frame or shutter; and

3) the shutter is easily installed by means of the interlocking, sliding plate members without the necessity of supporting the shutter while drilling holes or turning screws. The invention facilitates installation, cleaning, repair, removal, and replacement of the shuttered window, as well as other activities where wide clearance is desirable. Moreover, the hinge assembly presents a neat and pleasing appearance on the shutter.

A shutter assembly including the expandable hinge assemblies, and shutter panels with shutter stile side extensions is also included herein. Advantages of the shutter stile side extension include the following: 1) helps to block light coming in along the edge of the window even when the shutter panels are closed; 2) the shutter panels fit closely and attractively into the window frame; 3) facilitates proper placement of the hinge assemblies and expansion of the hinge assemblies and the shutter panels to the expanded open position, so that the window can easily be tilted, removed, or otherwise worked on. Being able to remove or tilt the window inwardly makes cleaning both sides of the window from inside the house easy.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is an exploded perspective view of a slidable hinge assembly according to the present invention;

FIG. 2 is a perspective view of four hinge assemblies according to the present invention, shown in a closed position on a pair of shutters;

FIG. 3 is a perspective view of two hinge assemblies according to the present invention, shown in an open position on a left hand shutter, and an expanded perspective view of the hinge assembly; and

FIG. 4 is a perspective view of two hinge assemblies according to the present invention, shown in an expanded position on a right hand shutter, and an expanded perspective view of the hinge assembly.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

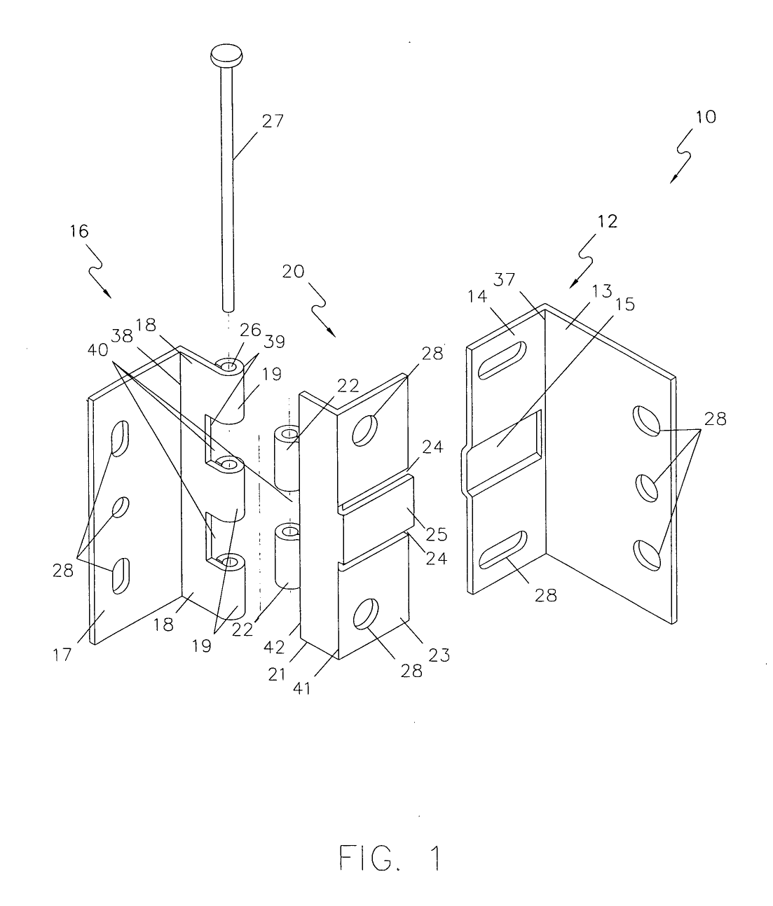

Turning first to FIG. 1, an expandable hinge assembly, generally referred to herein as 10, according to the present invention comprises basically three pieces: two angled mounting plate members 12, 16, and an angled connecting member 20. As seen in FIG. 1, the angled window frame mounting plate member 12 is a substantially planar, substantially rectangular-shaped member with a right-angle bend or fold 37 forming two substantially planar, rectangular-shaped segments 13, 14, a first one of which is a substantially rectangular-shaped window frame segment 13 that can be attached by suitable means, such as screws 43 through fastener apertures 28, to an inside surface of the window frame 32.

The other, second segment 14 of the window frame mounting plate member 12 is a continuation of the same window frame mounting plate member 12 extending from the longitudinal fold 37 of the window frame segment 13 at about a right angle to the window frame segment 13 and includes a recessed groove, or depression 15, which is preferably substantially rectangular in shape and oriented substantially perpendicularly to the window frame plate longitudinal fold 37.

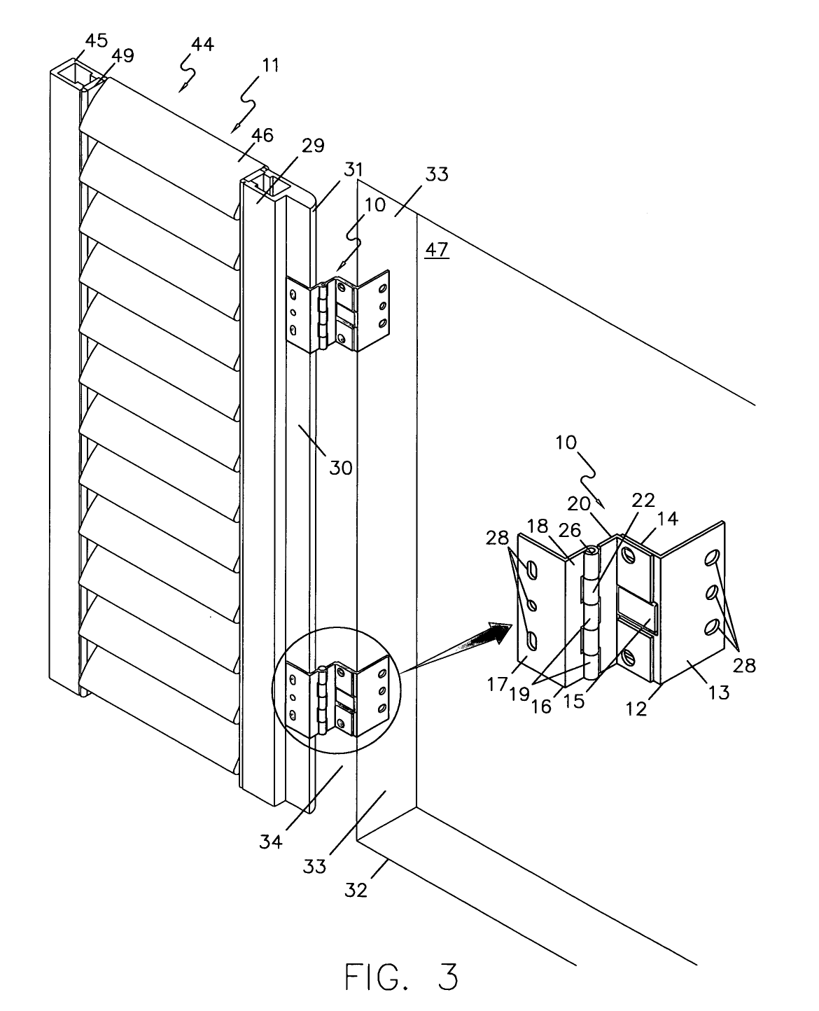

Thus, the window frame mounting plate member 12 comprises two substantially planar segments 13, 14 that are substantially perpendicular to one another. The first window frame segment 13 is attachable, preferably by screws 43, to an inside surface of the window frame 32. The other, second window frame segment 14 fits closely against an adjacent surface (corner) of the window frame 32 (see window frame front side 34 in FIG. 3, for example). The second, free window frame segment 14 comprises the frame plate depression 15, which extends substantially perpendicular to a longitudinal axis (or the longitudinal fold 37) of the second window frame segment 14 of window frame mounting plate member 12.

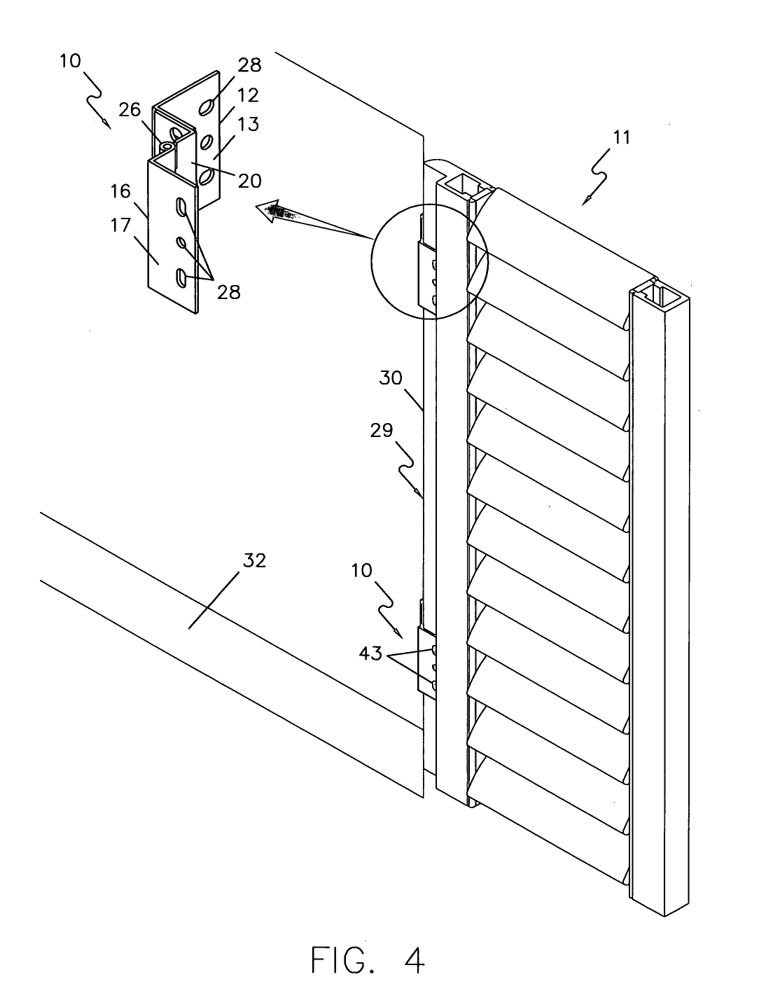

Referring still to FIG. 1, an angled shutter mounting plate member 16 comprises a substantially planar, substantially rectangular-shaped member with a right-angle bend, or longitudinal fold 38, forming two substantially planar, substantially rectangular-shaped segments 17, 18, the first one of which is a substantially rectangular-shaped shutter plate segment 17 that can be attached by suitable fastening means, such as screws 43 through fastener apertures 28, to an outer shutter stile 29 (also see FIG. 4). The other, second segment 18 of the shutter mounting plate member 16 is a continuation of the shutter mounting plate member 16 extending from the shutter plate longitudinal fold 38 at approximately a right angle to the shutter plate segment 17. The free, second shutter plate segment 18 of the shutter mounting plate member 16 comprises two or more substantially cylindrical shutter plate knuckles 19, which are preferably of uniform length and width, along the shutter plate longitudinal, free edge 39 opposite the shutter plate longitudinal fold 38. The shutter plate knuckles 19, which curve away from the shutter plate segment 17 in FIG. 1, are separated by gaps 40. In the presently preferred hinge assembly shown in FIG. 1, each gap 40 is about equal in vertical dimension to any one of the knuckles 19, and the gaps 40 are of uniform length and width.

Thus, the shutter mounting plate member 16 includes two substantially planar segments 17, 18 that are substantially perpendicular to one another. The first shutter plate segment 17 is attachable to a shutter stile 29 along the outer edge of the shutter panel 11. The other, second shutter plate segment 18 fits closely (snugly) against the outside of the outer shutter stile 29. The shutter plate segment 18 terminates at its longitudinal edge 39 in at least one, and preferably three, knuckles 19. The ends of the shutter plate knuckles 19 are preferably parallel to one another and the knuckles are separated by even gaps 40.

Referring still to FIG. 1, the angled connecting member 20 comprises a substantially planar, substantially rectangular-shaped member with a right-angle bend, or longitudinal fold 41, forming two substantially planar connecting plate segments 21, 23, one 21 of which terminates along the longitudinal edge 42 opposite the connecting plate longitudinal fold 41 in one or more substantially cylindrical connecting plate knuckles 22 that extend from a longitudinal, free edge 42 of the connecting member 20 and corresponding in number to the number of gaps 40 between the shutter plate knuckles 22 of the shutter mounting plate member 16, and corresponding also in length and width to the same dimensions of the corresponding gaps 40 on the shutter mounting plate member 16. The connecting knuckles 22 on the connecting member 20 are so positioned that they will fit into the gaps 40 between the shutter plate knuckles 19 of the shutter mounting plate member 16. The shutter mounting plate member 16 and connecting member 20 may thus be joined together by inserting the connecting knuckles 22 of the connecting member 20 into the gaps 40 between the shutter plate knuckles 19 of the shutter mounting plate member 16 and aligning the knuckles 19, 22 of both plate members 16, 20 so that the knuckles form a continuous barrel shape with a central barrel aperture 26, into which a retaining pin 27 is inserted, locking the two plate members 16, 20 together. There are preferably two of the connecting knuckles 22 on the connecting member 20 interposed between three of the shutter plate knuckles 19 on the shutter plate member 16.

The other, second connecting plate segment 23, which is a continuation of the connecting member 20, extends from the longitudinal fold 41 of the connecting member at about a right angle to the first connecting plate segment 21. As shown in FIG. 1, the second connecting plate segment 23 is cut transversely by two slots 24, which are generally linear and oriented substantially perpendicularly to the longitudinal fold 41, thereby forming a tongue 25 between them. The connecting plate tongue 25, which is substantially rectangular-shaped, is also oriented substantially perpendicularly to the connecting plate longitudinal fold 41 (or the longitudinal axis of the connecting member 20) and extends slightly above the remainder of the connecting plate segment 23.

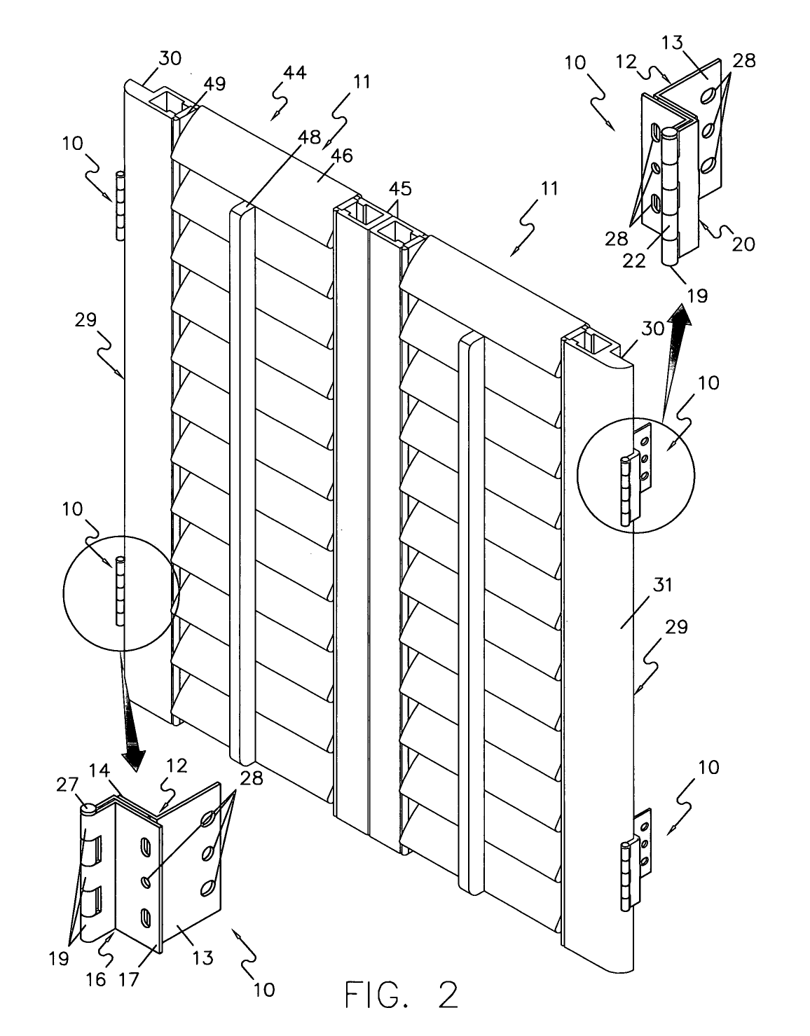

Further, the slots 24 are so positioned that the connecting plate tongue 25 corresponds closely, both in location and in dimensions, to the preferably substantially rectangular-shaped depression 15 on the window frame mounting plate member 12. The window frame mounting plate member 12 and the connecting member 20 may thus be joined together by aligning the tongue 25 on the second connecting plate segment 23 of the connecting member 20 with the frame plate depression 15 on the free segment 14 of the window frame mounting plate member 12, and sliding the two plate members 12, 20 toward one another, so that the connecting plate tongue 25 slides into the frame plate depression 15 and the remainder of the connecting plate segment 23 slides against the second, free window frame segment 14, leaving the connecting plate tongue 25 and the remainder of the segment facing and fitting snugly against opposite sides of the second, free window frame segment 14 of the window frame mounting plate member 12, and the two plate members 12, 20 are thus interlocked. Thus, the hinge assembly 10 is slidable. In this interlocked position, the tongue 25 is level with the remainder (either side of the depression) of the second window frame segment 14, so that the hinge assembly 10 fits smoothly when it is in the closed position (see FIG. 2).

Further, fastener apertures 28 in the second connecting plate segment 23 of the connecting member 20 and the second, free window frame segment 14 of the window frame mounting plate member 12 are positioned so that when the two connecting plate segments interlock, the fastener apertures 28 in the second connecting plate segment 23 of the connecting member 20 will generally align with the fastener apertures 28 in the second, free segment 14 of the window frame mounting plate member 12. Screws 43 or other suitable fasteners are then screwed in through both connecting plate segments fastening them securely together and into the window frame 32. The connecting plate tongue 25 and the bottom of the frame plate depression 15 may or may not each include a fastener aperture 28. If they do, these two apertures 28 will align when the tongue 25 is in the depression 15.

Thus, the connecting member 20 comprises two substantially planar segments 21, 23 that are substantially perpendicular to one another, a first one 21 of which comprises at least one connecting plate knuckle 22 along a longitudinal edge 42 of the first connecting plate segment 21. The other, second connecting plate segment 23 comprises at least one tongue 25, preferably with similarly shaped tabs 23a on either side of the tongue 25. The plane of the tongue 25 is different than the plane of the remainder of the first connecting plate segment 21 (e.g., tabs 23a). The tabs 23a are created by presently preferred, substantially parallel slots 24 on either side of the tongue 25.

The shutter plate segments 17, 18 of the shutter mounting plate member 16 may be formed by the bend in one piece of metal, plastic, or other material, as outlined above, or the two shutter plate segments 17, 18 may be two separate pieces that are fused together along the longitudinal “fold” 38, as by welding. The same is true of the segments 13, 14 and 21, 23 of the other two plate members 20, 12.

When the hinge assembly 10 is in use, then, the knuckles 19, 22 of the shutter mounting plate member 16 and the connecting member 20 are detachably interlockable with one another. The second connecting plate segment 23 of the connecting member 20 is in turn detachably interlockable with the second, free window frame segment 14 of the window frame mounting plate member 12 as described herein. As the connecting plate tongue 25 of the second connecting plate segment 23 slides onto the top of the frame plate depression 15 of the second window frame segment 14, the tabs 23a on the second connecting plate segment 23 slide under corresponding portions of the second window frame segment 14, which are on either side of the depression 15. This is easily accomplished by a layperson of any age. Note that the relative positions of the tongue 25 and depression 15 can be reversed in an alternate embodiment (not shown), so that the depression is in the second connecting plate segment 23 and the tongue is in the second window frame segment 14.

The fastener apertures 28 in either the second, free segment 14 of the window frame mounting plate member 12 and/or the fastener apertures 28 in the second segment 23 of the connecting member 20 may be circular or oblong in shape. They may be slotted to allow some adjustment to correct for errors in drilling and positioning of the apertures on the window frame 32. Likewise, the fastener apertures 28 in the first window frame segment 13 of the window frame mounting plate member 12, and the fastener apertures 28 in the shutter plate segment 17 of the shutter mounting plate member 16 may be slightly oblong or slotted to allow for a reasonable margin of error in positioning holes in the window frame 32 and/or the outer shutter stile 29.

Turning to FIG. 2, in use, two or more hinge assemblies 10 are attached to a rear side 30 of a side extension 31 of the outer shutter stile 29 of an interior window shutter panel 11 (inside the house or other building) by means of screws 43 through fastener apertures 28 in the first shutter plate segment 17 of the shutter mounting plate member 16 portion of the hinge assembly 10. When attached to the outer shutter stile 29, the shutter mounting plate member 16 is positioned so that the shutter plate segment 18 of the shutter mounting plate member 16 abuts against the outer edge of the stile extension 31, and the shutter mounting plate member 16 fits snugly against the shutter stile extension 31. Hinge assemblies 10 are attached to the outer stile 29 of the opposite shutter panel 11 in like manner, preferably with two hinge assemblies and two shutter panels 11 for each standard-type window. With the shutter panels 11 in a closed position as seen in FIG. 2, the window frame segment 13 of the window frame mounting plate member 12 of the hinge assembly 10 projects rearward at an angle perpendicular to the plane of the shutter panel 11.

Referring to FIGS. 3 and 4, two or more hinge assemblies 10 are attached to the inside surface 33 of the window frame 32 with screws 43 or other suitable fasteners inserted through the fastener apertures 28 in the window frame segment 13 of the window frame mounting plate member 12 of the hinge assembly 10. When attached to the window frame 32, the angled window frame mounting plate member 12 is positioned so that the free, window frame segment 14 of the mounting plate member 12 abuts against the window frame front edge 34 and the angled mounting plate wraps around the adjacent corner 35 of the window frame 32 and the free, window frame segment 14 of the window mounting plate member 12 fits snugly (closely) against the window frame front side 34. When the shutter panel 11 is opened, the shutter mounting plate member 16 pivots on the retaining pin 27 in the barrel aperture 26, while the connecting member 20 and window frame mounting plate member 12 remain fixed, and the shutter panel 11 swings open away from the window frame 32, clearing the window opening 36 by the width of the second connecting plate segment 23 of the connecting member 20. In addition, the wrap-around design of the hinge mounting plate members 12, 16 is believed to provide added strength and stability against twisting and sagging of the shutters.

The hinge assembly 10 on the shutter panel 11, then, is rotatable between a closed position where the shutter panels 11 are closed over the shuttered window, as shown in FIG. 2, a shutter open position where the shutter is flipped back against the wall adjacent the window, as shown in FIG. 4, and an expanded open position with the shutter panel 11 against the wall adjacent the window as shown in FIG. 3. The shutter panels 11 are out of the way and the window is easy to access when the hinge assemblies 10 on the shutters are in the expanded open position (see FIG. 3). A user can selectively move the shutter panels 11 with their hinge assemblies 10 between the closed position, the open position, and the expanded open position.

Also, the screws 43 in the fastener apertures 28 on either side of the tongue 25 in the connected connecting member 20 and the window frame mounting plate member 12 of the hinge assemblies 10 can be unscrewed, if desired, and the shutter panel 11 can be removed by separating the connecting members 20 from the respective window frame mounting plate members 12 on the window frame 32. The shutter panel 11 can then be replaced by re-attaching the connecting members 20 on the shutter panel 11 to the mounting plate members 20 on the window frame 32.

The present invention also includes a shutter assembly 44 comprising at least two shutter panels 11, and at least two expandable hinge assemblies 10 attachable to the shutter panels 11 and to a window frame 32. Each shutter panel 11 comprises an outer shutter stile 29 having a stile side extension 31 along its outer side (the side furthest from the center of the window). The stile side extension 31 helps to block light coming in from the window 47 when the shutter panels 11 are closed, and helps the shutter panels 11 to fit closely and attractively into the window frame 32. Another advantage of the stile side extension 31 is that it facilitates proper placement of the hinge assemblies 10, and expansion of the hinge assemblies 10 and the shutter panels 11 to the expanded open position as seen in FIG. 4, so that the window 47 can easily be tilted, removed, or otherwise worked on. Being able to remove or tilt the window 47 inwardly makes cleaning both sides of the window from inside the house easy.

As seen in FIGS. 2 and 3, the stile side extension 31 preferably has a substantially planar lower surface (at the rear of the shutter panel) for accommodating the shutter mounting plate member 16 and a substantially smooth, curved upper surface (at the front of the shutter panel) for aesthetic reasons. The stile side extension 31 preferably accounts for about one half the width of the outer stile 29. The stile side extension 31 is about one half as thick as the outer stile 29, so that the stile side extension 31 fits closely against the wall adjacent the shuttered window 47 when the shutter panel 11 is closed.

The inner shutter stiles 45, which are at the center of the window 47 when the shutter panels 11 are closed, need not include stile side extensions 31. As seen in FIG. 2, slats 46 of the shutter panels 11 optionally include a central shutter control rod 48 for opening and closing the shutter slats 46, or the shutter slats may not be movable, as desired. Pins (not shown) at each end of the slats 46 connect to a one-piece shutter stile insert 49 that fits into open arms of the outer and inner stiles 29, 45 (see FIG. 2). Moving the shutter control rod 48 up and down tilts the shutter slats 46 up and down on their pins. End caps (not shown) can be placed on the top ends, and optionally the bottom ends, of the shutter stiles for aesthetic reasons.

Referring again to FIGS. 1 and 3, in a typical installation, the shutter mounting plate member 16 will first be joined to the connecting member 20 by aligning the knuckles 19, 22 and inserting the retaining pin 27 through the barrel aperture 26, then attached to the shutter panel 11. They are preferably then joined to the window frame mounting plate member 12, which will be already attached to the window frame 32. By this method, the installer need not support the weight of the shutter panel 11 while drilling holes or turning screws into the shutter panel 11 or window frame 32. When ready to install, the installer need only slide the hinge tongues 25 on the connecting members 20, which are on the shutter panel 11, into the depressions 15 on the window frame mounting plate members 12, and allow the hinge assembly 10 to support the shutter panel 11 while he or she inserts screws 43 or the like through the fastener apertures 28 in the second connecting plate segment 23 and window mounting plate free segment 14 and into the window frame 32. This does not require the services of a skilled worker and can be accomplished by a layperson. In an alternate installation, the hinge assembly 10 may be completely assembled as described above prior to attachment to the shutter panel 11, or the shutter mounting plate member 16 may be first attached to the shutter panel 11, and the connecting member 20 and window frame mounting plate member 12 of the hinge assembly 10 may be joined thereafter.

In like manner, the window shutter panel 11 may be temporarily removed from the window frame 32 without removing either mounting plate member 12, 16 from the shutter panel 11 or window frame 32. When removal is desired, the screws 43 or other fasteners are first removed from the second connecting plate segment 23 of the connecting member 20 and the second, free segment 14 of the window frame mounting plate member 12. The shutter panel 11 can then be removed by simply pulling the connecting members 20 away from the window frame mounting plate members 12 and sliding the connecting plate tongues 25 out of the frame plate depressions 15. This can also be accomplished by a layperson of any age.

The hinge assembly 10 can be used equally as well for exterior shutters, interior or exterior doors or gates, or for any other applicable object in rotational relationship to a second object. When used on doors, the hinge assembly 10 permits the doors to open to a greater width, away from the door opening, without a hinge barrel or other protrusion into the opening. The hinge assembly makes it easier for movers to move large objects, such as bureaus and dining room cabinets, through a doorway without removing the door and hinges. A greater number of hinges can be utilized when increased support strength is desired, such as for heavier shutters, doors, or gates. The hinge assembly 10 can also be constructed with greater dimensions and heavier materials for added strength or to fit more closely to different sized windows and doorways.

In an alternate embodiment, the window frame mounting plate and connecting member can be manufactured as one piece, which joins to the shutter mounting plate in the same manner that the connecting member described above joins the shutter mounting plate. The window frame mounting plate still wraps around the corner of the window frame, fastened with screws or the like into the window frame front side as before, with the added strength and stability of the wrap-around attachment described previously. The hinge barrel will remain out of the window opening as described hereinabove, retaining the advantages described herein, although the slidable installation and removal feature is not present in this alternate embodiment. The mounting plate in another, similar alternate embodiment could omit the apertures for fastening the plate to the front side of the window frame; the advantages of the hinge barrel out of the window opening remaining in this alternate embodiment.

The mounting plates can assume various nonrectangular shapes without interfering with the functioning of the hinge assembly. Different shaped hinges may be desired for aesthetic reasons, particularly when the hinge is used on the interior of a home, and any number of decorative hinge designs, which can easily be imagined (e.g., fluted edges, curved edges), are suitable for inclusion herein.

From the foregoing it can be realized that the described hinge assembly of the present invention may be easily and conveniently utilized for attaching shutters to a window frame without restricting the movement of the window with the shutter through the window opening. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 hinge assembly
11 window shutter
12 window frame mounting plate member
13 first window frame segment
14 second, free window frame segment
15 frame plate depression
16 shutter mounting plate member
17 first shutter plate segment
18 second, free shutter plate segment
19 shutter plater knuckles
20 connecting member
21 first connecting plate segment
22 connecting plate knuckles
23 second connecting plate segment
24 slots
25 connecting plate tongue
26 barrel aperture
27 pin
28 fastener apertures
29 outer shutter stile
30 stile extension rear side
31 stile extension
32 window frame
33 window frame inside surface
34 window frame front side
35 window frame corner
36 window opening
37 window frame plate longitudinal fold
38 shutter plate longitudinal fold
39 shutter plate longitudinal edge
40 gaps
41 connecting plate longitudinal fold
42 connecting plate longitudinal edge
43 screws
44 shutter assembly
45 inner shutter stile
46 shutter slats
47 window
48 shutter control rod
stile insert

What is claimed is:

1. An expandable hinge assembly for movably attaching an interior shutter to a window frame, the hinge assembly comprising:
(a) a window frame mounting plate member comprising two substantially planar segments that are substantially perpendicular to one another, a first one of which is attachable to an inside surface of the window frame, the other, second one of the window frame segments comprising a frame plate depression;
(b) a shutter mounting plate member comprising two substantially planar segments that are substantially perpendicular to one another, a first one of which is attachable to the shutter, the other, second one of the shutter plate segments comprising at least one shutter plate knuckle on a longitudinal edge of the second shutter plate segment; and
(c) a connecting member comprising two substantially planar segments that are substantially perpendicular to one another, a first one of which comprises at least one connecting plate knuckle along a longitudinal edge of the first connecting plate segment; the other, second segment of which comprises at least one connecting plate tongue corresponding to the frame plate depression;
wherein the knuckles of the shutter mounting plate member and the connecting member are detachably interlockable with one another; and the connecting plate tongue is detachably insertable in the corresponding frame plate depression.

2. The hinge assembly according to claim 1, wherein the frame plate depression extends substantially perpendicularly to a longitudinal axis of the second window frame segment, and the connecting plate tongue is oriented substantially perpendicularly to a longitudinal axis of the connecting plate member.

3. The hinge assembly according to claim 2, wherein the connecting plate tongue extends above the remainder of the first connecting plate segment; the connecting plate tongue being closely fittable into the frame plate depression so that the tongue is level with the remainder of the second window frame segment.

4. The hinge assembly according to claim 2, wherein the second, free window frame segment is closely fittable against an adjacent surface of the window frame, and the second shutter plate segment is closely fittable against an adjacent surface of the shutter stile.

5. The hinge assembly according to claim 3, wherein the knuckles of the two plate members comprise a central barrel aperture, a hinge pin being insertable through the barrel apertures of the knuckles when the knuckles are in an interlocked position.

6. The hinge assembly according to claim 5, wherein two of the connecting knuckles on the connecting member are interposed between three of the shutter plate knuckles on the shutter plate member.

7. The hinge assembly according to claim 6, wherein the connecting plate knuckles closely fit into a corresponding number of gaps between the shutter plate knuckles.

8. The hinge assembly according to claim 2, wherein the middle connecting member comprises two slots extending perpendicularly across the length of the connecting member, the slots forming the connecting plate tongue.

9. The hinge assembly according to claim 8, wherein the connecting plate tongue on the second connecting plate segment is slidable into the frame plate depression on the second window frame segment.

10. The hinge assembly according to claim 8, wherein the slots form the connecting plate tongue and two adjacent tabs on either side of the connecting plate tongue.

11. The hinge assembly according to claim 10, wherein the connecting plate tongue on the second connecting plate segment are slidable into the frame plate depression on the second window frame segment, as the tabs on the second connecting plate segment are slidable under corresponding portions of the second window frame segment on either side of the depression.

12. The hinge assembly according to claim 3, wherein the second connecting plate segment of the connecting member is interlockable with the second, free window frame segment of the window frame mounting plate member.

13. The hinge assembly according to claim 1, wherein the window frame mounting plate and connecting member are formed from one piece of a metal material.

14. A window shutter assembly comprising at least two shutter panels, and at least two expandable, three-piece hinge assemblies attachable to the shutter panels, each of the hinge assemblies comprising:
(a) a window frame mounting plate member comprising two substantially planar segments that are substantially perpendicular to one another, a first one of which is attachable to an inside surface of a window frame, the other, second one of the window frame segments comprising a frame plate depression;
(b) a shutter mounting plate member comprising two substantially planar segments that are substantially perpendicular to one another, a first one of which is attachable to the shutter panel, the other, second one of the shutter plate segments comprising at least one shutter plate knuckle on a longitudinal edge of the second shutter plate segment; and
(c) a connecting member comprising two substantially planar segments that are substantially perpendicular to one another, a first one of which comprises at least one connecting plate knuckle along a longitudinal edge of the first connecting plate segment; the other, second segment of which comprises at least one connecting plate tongue corresponding to the frame plate depression;
wherein each of the shutter panels comprises at least one outer shutter stile, the outer shutter stile comprising a stile side extension on its outer side.

15. The shutter assembly according to claim 14, wherein the knuckles of the shutter mounting plate member and the connecting member are detachably interlockable with one another; and the connecting plate tongue is detachably insertable in the corresponding frame plate depression.

16. The shutter assembly according to claim 15, wherein the stile side extension has a substantially planar lower surface, and a substantially smooth, curved upper surface.

17. The shutter assembly according to claim 15, wherein the width of the stile side extension is about one half the width of the outer shutter stile, and the stile side extension is about one half as thick as the outer shutter stile.
